(19) United States
(12) Patent Application Publication
(10) Pub. No.: US 2003/0177484 A1
(43) Pub. Date: Sep. 18, 2003

(54) Firewall class loader

(76) Inventors: Allaert J. D. Bosschaert, Wijster (NL); Andreas Moesching, Dublin (IE); Sean P. Baker, Greystones (IE)

Correspondence Address: LACASSE & ASSOCIATES, LLC, 1725 DUKE STREET, SUITE 650, ALEXANDRIA, VA, 22314, US

(21) Appl. No.: 10/249,114

(22) Filed: Mar. 17, 2003

Related U.S. Application Data
(60) Provisional application No. 60/365,046, filed on Mar. 15, 2002.

(51) Int. Cl. G06F 9/44

(52) U.S. Cl. 717/166

(57) ABSTRACT

A unique class loader called the Firewall Class Loader is described wherein the firewall class loader either uses positive filters or a combination of positive and negative filters. Negative filters provide for a list of classes that a class loader will not pass load requests to its parent in the class loader hierarchy. On the other hand, positive filters provide for a list of classes that a class will pass load requests to its parent in the class loader hierarchy, and all other requests would be filtered out. Variations and combinations of Firewall Class Loaders enable specialized configurations to increase speed and ensure that each vendor's applications work correctly in all user deployments.

### CROSS REFERENCE TO RELATED APPLICATIONS

The present application claims the benefit of provisional patent application “Firewall Class Loader”, serial No. 60/365,046, filed on Mar. 15, 2002.

### COPYRIGHT NOTICE

Portions of the disclosure of this patent document, in particular Computer Program Listing Appendix A, contain unpublished material which is subject to copyright protection. The copyright owner, Iona Technologies, has no objection to the facsimile reproduction by anyone of the patent document or the patent disclosure, as it appears in the U.S. Patent and Trademark Office patent files or records, but otherwise reserves all rights whatsoever.

### BACKGROUND OF INVENTION

1. Field of Invention

The present invention relates generally to the field of resource loaders. More specifically, the present invention is related to resource or class loading.

2. Discussion of Prior Art

Java Virtual Machine®, or JVM, is an abstract computing machine (or virtual machine) that provides for a platform-independent execution environment that converts Java bytecodes into machine language for execution. Most programming languages compile source code directly into machine code that is designed to run on a specific microprocessor architecture or operating system, such as Windows® or UNIX®. A JVM enables Java bytecode to be executed as actions or operating system calls on any processor regardless of the operating system.

Every application vendor needs to ensure that their applications work correctly in all user deployments. Most JVM implementations require the ability to load JVM class files, and it is the JVM class loader's role to load referenced JVM classes which have not already been linked to the runtime system. In Java, class loading is one of the areas where this can be problematic, as the Java runtime has ways of giving the user control over the class loading. A user can modify the CLASSPATH variable, or install libraries in a specific directory, where they are automatically loaded from by the Java runtime. This allows the user to (sometimes unknowingly) configure the class loading in such a way that it will cause the application to work incorrectly. It is a challenge for the application vendor to guarantee the working of their product when this can be influenced by the way the user has configured the Java runtime environment.

On the other hand, application container or application server vendors face another problem. Their goal is to allow customers to install applications in their container with as little restrictions as possible. The application container may be compliant to a certain open standard, and the vendor does not wish to violate this standard in any way. This can be a challenge for the class loading functionality, as the application container may internally use/expose classes or resources not defined in the standard. There is a possibility that these classes conflict with the user-installed application. This, under normal Java class loading rules, could cause the installed application to work incorrectly.

The JVM class loader supports a hierarchy of class loaders, with the system class loader at the root. The JVM class loading mechanism works as follows:

When a class needs to be loaded (when there is a “class fault”, to use an analogy from virtual memory systems), the system starts at a node in the hierarchy, that node being the class loader for the current class.

That class loader automatically passes the request (to load a class) upwards towards the root (the system class loader), and this is done in turn by each of the class loaders between the leaf and the root.

When the request arrives at the root, it determines if the missing class is one that it knows how to load and, if so, it loads an incarnation (implementation) of that class. In fact, the root loads the class if it is configured to do so (in the case of, for example, Java, the system class loader uses its system class path and the extensions directory to find classes that it is allowed to load).

If the root cannot load the class, it then indicates this to the class loader that directly passed the request to it by raising a class fault (throwing an exception or returning null are examples of how class faults can be implemented).

That class loader then tries to load the class. If it cannot load the class, then it also indicates this to the class loader that passed the call directly to it. This continues down the hierarchy until either the class gets loaded or an indication of failure (to load the class) reaches the originating class loader. It tries to load the class; and if it fails, then it returns an indication of an error back to the application.

A prior art example of class loader filters is a product known as DrJava. A brief description of DrJava is provided in the paper entitled “DrJava: A lightweight pedagogic environment forJava”. DrJava provides for a Limiting Class Loader that can be configured with a list of classes (filter), and it uses this to determine whether or not to pass the request to load a class to its parent in the hierarchy (requests to load a class that is in the list are not passed upwards). If the Limiting Class Loader decides that the request should not be passed to its parent, it then informs the class loader that passed the request to it regarding its inability to pass the request (in Java, for example, it could return an exception to the class loader that passed the request to it). When a class loader passes a request to load a class to the Limiting Class Loader and the Limiting Class loader decides not to pass the request to its parent, this looks to the originating class loader as if all of the classes above it in the hierarchy have refused or were unable to load the class. Thus, Drjava's limiting class loaders only allows the specification of negative filters, wherein such negative filters define which class loading requests are not allowed to propagate upwards in a class loader hierarchy.

DrJava also introduces two other class loader variants: StickyClassLoader and ToolsJarClassLoader. These variants are needed in part to handle limitations with Limiting Class Loaders, as explained below.

StickyClassLoader:

A StickyClassLoader is a class loader that works as the union of two class loaders but always tries to delegate to the first of these. The purpose for this class is to ensure that classes loaded transitively due to a class's loading are also loaded with the right class loader. For example, if class A contains a reference to class B but the specific class B is unknown to clients of class A, class A is loadable by the standard class loader but class B needs to be loaded with a (known) custom class loader.

If class A were loaded using the standard class loader, it would fail because this would cause the transitive loading of class B to be done by the system loader as well. If class A were loaded with the custom loader, the same thing would happen—the custom loader would delegate to the system loader to load class A (since it doesn't load non-custom-loader-requiring classes), but this would associate class A with the system class loader. (Every class is associated with the loader that called ClassLoader.defineClass(bytefj, int, int) to define it in the JVM.) This association would load class B by the standard loader.

The StickyClassLoader class is used to get around the above-mentioned problem. To overcome this problem, the StickyClassLoader associates itself with all classes it loads even though the actual work is done by the two loaders it delegates to. It does this by calling ClassLoader fndResource(java.lang.String) on the subordinate loaders to get the class data, but then calls ClassLoader.defineClass(bytefj, int, int) itself to preserve the association.

ToolsJarClassLoader:

ToolsJarClassLoader is a class loader that tries to load classes from the tools Java archive (jar). It should be noted that the ToolsJarClassLoader does not delegate to the system loader. Its purpose is to be used from StickyClassLoader, which just needs getResource.

Use of StickyClassLoader and ToolsJarClassLoader tries to resolve the problems when using the Limiting Class Loader.

FIG. 1 illustrate a possible usage of the limiting class loader of the prior art. In our first look at FIG. 1, Sub-system A Class Loader 102 is ignored. In FIG. 1, the Limiting Class Loader 104 can be configured to ensure that no class loading requests that the User Class Loader 100 can handle reach the System Class Loader 106. Therefore, if the System Class Loader 106 is configured to be able to load a particular class related to the application level, and the Limiting Class Loader 104 is configured not to pass up (in the hierarchy) requests to load this class, then requests to load this class will not be passed to the System Class Loader 106. Instead, the User Class Loader 100 will be responsible for loading the class. The benefit of this is that the User Class Loader 100 has more control over which actual implementation of the class is loaded and how it is loaded. For example, if the System Class Loader 106 is configured to load a different implementation of the class than the User Class Loader 100, then it will be the latter rather than the former that will get a chance to load the class.

Introducing the Sub-system A Class Loader 102 helps to emphasize the point. The Limiting Class Loader 104 would now be configured not to pass up any class loading requests relating to classes that the Subsystem A Class Loader 102 or the User Class Loader 100 can handle. It is common in Java for the system class path to contain entries that will cause the wrong implementation of a class to be loaded. This may arise for a number of reasons, for example, because Sub-system B was initially loaded onto a machine and the system class path may still have entries associated with that sub-system. When Sub-system A is being run instead, it is important that the System Class Loader does not load an implementation of a class appropriate to Sub-system B but not appropriate to Sub-system A. Without the limiting class loaded, the System Class Loader 106 would be asked to load the class, and it could find the inappropriate implementation of the class using its system class path. This would be the case despite the fact that the class loader appropriate to Sub-system A was installed in the system.

If properly configured (to know the classes used by the Sub-system A and the application level), the Limiting Class Loader 104 would prevent (filter out) the request going to the System Class Loader 106 and allow the Class Loader for Sub-system A 102 to load the class. Thus, a wide range of misconfigurations of the System Class Loader (for example, inappropriate entries in the system class path or entries in the extensions directory) will no longer cause such difficulties. This increases the ease-of-use for users of Sub-system A and technologies built on top of it, and it reduces the support load for the vendor of Sub-system A and technologies built on top of it.

What is needed is a method and a system to overcome the limitations of the limiting class loader, and further doing so without the use of additional variant class loaders such as the prior art StickyClassLoader and ToolsJarClassLoader. Whatever the precise merits, features, and advantages of the above-mentioned prior art, they fail to achieve or fulfill the purposes of the present invention.

### SUMMARY OF THE INVENTION

The present invention provides for a unique class loader called the “Firewall Class Loader”, which selectively filters requests traversing a class loader hierarchy. The Firewall Class Loader uses positive, negative, or a combination of positive and negative filters. Positive filters define a list of classes a class loader is allowed to pass on to its parent in a class loader hierarchy (thus, all other requests are filtered out). Negative filters define a list of classes a class loader is not allowed to pass on to its parent in a class loader hierarchy. In an extended embodiment, more than one Firewall Class Loader are implemented in a given class loader hierarchy.

Another embodiment provides for an automatic (or manual) inspection of a JVM (i.e., the system or whatever is above that point in the class loader hierarchy). In yet another embodiment, the present invention is used to support two similar sub-systems (for example, two Application Servers) in the same address space and/or application. A benefit of the present invention is that two Application Servers can be supported even though it may be difficult or impossible to configure the System Class Loader to know how to load classes associated with more than one Application Server.

The unique class loader of the present invention provides a speed advantage (over the disclosed prior art) by maintaining a smaller filter list that can be efficiently loaded by the Firewall Class Loader. The filter list is smaller for two reasons. Firstly, a typical System Class Loader has to deal with fewer classes than a complex application, especially one built on a complex sub-system such as an Application Server. Secondly, the nested structure of classes and their containers (Java packages) are exploited for speed. The System Class Loader has to deal only with a small number of these containers. It would also be possible to take advantage of the nested structure of classes and their containers using either a set of positive filters or a set containing both positive and negative filters. This setup reduces the number of filters and, hence, speeds up the task carried out by the Limiting Class Loader.

### BRIEF DESCRIPTION OF DRAWINGS

FIG. 1 illustrates a possible usage of the limiting class loader of the prior art.

FIG. 2 shows some usages of the present invention's Firewall Class Loaders (FWCL).

FIG. 3 illustrates an example of the present invention's FWCL used in conjunction with an application container system.

FIG. 4 illustrates a complex system that utilizes the following three FWCLs: J2EE FWCL, Servlet Engine Plugin FWCL, and JART FWCL.

FIG. 5 illustrates the use of multiple FWCLs in conjunction with multiple application servers.

FIG. 6 illustrates the use of multiple FWCLs in conjunction with multiple sub-systems.

FIG. 7 illustrates an alternative implementation of the class loader hierarchy of FIG. 6.

FIG. 8 illustrates the specific class loader hierarchy used in measuring the improvement in speed of the present invention's system over the prior art.

FIG. 9 illustrates an example using two Up Class Loaders.

FIG. 10 illustrates an example showing the functionality associated with the present invention's Preference Delegation Class Loader (PDCL).

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered an exemplification of the principles of the invention and the associated functional specifications for its construction and is not intended to limit the invention to the embodiment illustrated. Those skilled in the art will envision many other possible variations within the scope of the present invention. It should be noted that throughout the specification and claims, the terms “class” and “resource” can be used interchangeably. Additionally, the term JVM as used throughout the specification is envisioned to encompass, in a broader sense, an environment such as the Java Run-time Environment.

The present invention overcomes many limitations of the prior art Limiting Class Loaders by using of a unique class loader called the “Firewall Class Loader”. The Firewall Class Loader selectively filters requests by passing/blocking requests from traversing the class loader hierarchy. Such selective filtering is accomplished using either positive filters or a combination of positive and negative filters. Positive filters define a list of classes a class loader is allowed to pass on to its parent in a class loader hierarchy (thus, all other requests are filtered out). Negative filters define a list of classes a class loader is not allowed to pass on to its parent in a class loader hierarchy. Additionally, in one embodiment, more than one Firewall Class Loader are implemented in a given class loader hierarchy. One of the differences from the prior art is the use of positive filters (a Limiting Class Loader uses only negative filters). Positive filters have specific advantages over the exclusive use of Limiting Class Loaders.

A Firewall Class Loader is configured in a number of different ways, including, but not limited to, the following:

It is given a list of positive filters. A Firewall Class Loader that has only positive filters is referred to as Positive Firewall Class Loader (PFWCL).

It is given a list of negative filters. A Firewall Class Loader that has only negative filters is referred to as Negative Firewall Class Loader (NFWCL). It should be noted that because of the possibility of using wildcards, a NFWCL is not identical to the Limiting Class Loader.

A Firewall Class Loader that has both positive and negative filters that take advantage of the hierarchical nature of class names is referred to as a General Firewall Class Loader (GFWCL).

It should also be noted that the term Firewall Class Loader (FWCL) can refer to a NFWCL, PFWCL, or a GFWCL.

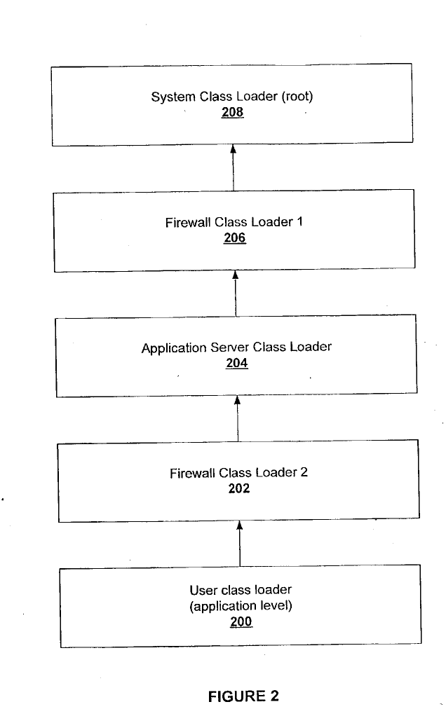

FIG. 2 shows some usages of the present invention's Firewall Class Loaders. An advantage of positive filters is that the filter information is found by inspecting what is above that point in the class loader hierarchy. So, the filter list for Positive Firewall Class Loader 1 206 is found by inspecting what is above it; that is, the System (represented by the System Class Loader (root) 208). For a Java application, the System is made up of the JVM run-time environment (although other similar environments can be used in conjunction with the present invention, such as C#/.NET run time environment). Therefore, the filter list for Positive Firewall Class Loader 1 206 is found by inspecting the JVM and making a list of the classes that it has responsibility for. Requests to load these classes are passed upwards; others could be rejected.

Further, in one embodiment, automatic inspection of the JVM (or the “System”, in a more general case—or more generally still, whatever is above that point in the class loader hierarchy) takes place. An inspection program inspects the JVM and extracts the filter list (the list of classes that upper level or levels are responsible for). A brief description of the automatic inspection process is provided later in the specification.

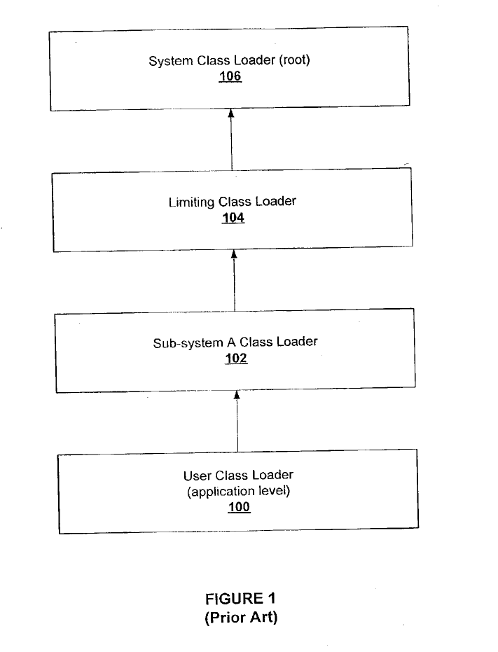

As a contrast, an inspection can also be done in the case of the prior art Limiting Class Loaders, but in this case the inspection has to be downwards from that node in the class loader hierarchy. It should be noted that such as scheme is provided for discussion purposes only, as such as an inspection scheme does not appear to be disclosed in the documentation of DrJava. In the case of the class loader hierarchy shown in FIG. 1, the (negative) filters for the Limiting Class Loader can be found by inspecting Sub-system A and the application level. Requests for any other classes would be passed upwards, whereas requests for classes used by Sub-system A or the application level would be rejected by the Limiting Class Loader.

Inspecting what is above a given point in a class loader hierarchy has advantages over inspecting what is below that point because computer systems are typically built in layers. Sub-systems are built on other sub-systems, and it is usual to know what each sub-system is built on top of but not to know what is built on top of each. For example, it is usual to know that a given Application Server is built on top of the Java JVM and also to know that a given application is built on top of a given Application Server. The writers of that Application Server will less frequently know of the existence of the applications built on top of it, and the JVM is so general that its writers will not know all of what is built on top of it.

Inspection upwards in the class loader hierarchy corresponds to inspecting what a given point is built on top of, and this matches a typical situation where it is clear what systems and sub-systems that a given point is built on top of.

Inspection downwards has another disadvantage in that what is below in the class loader hierarchy may be an open system that is regularly extended by a set of users/programmers that do not cooperate closely. In FIG. 2 (assuming that Positive Firewall Class Loader 2 202 isn't present), if a Limiting Class Loader were used instead of Positive Firewall Class Loader 1 206, then the (negative) filter set for that Limiting Class Loader would have to list those classes that Application Server Class Loader 204 and User Class Loader 200 should load. If the Application Server is an open system that supports facilities such as plug-ins (where the application level extends the code in the Application Server, thereby adding to classes that it loads), then any use of this facility would require a change to the Limiting Class Loader's filters. In contrast, the present invention's Positive Firewall Class Loader filters are more stable because they depend upon the System (in Java, this is the JVM).

The Limiting Class Loader would also need to have its filters updated if the application level changes. Application levels change regularly in many systems. These changes would often be more frequent than changes in the System level. Also, the user level could be “open”—that is, the set of classes that are loaded can change at runtime. This would not affect the operation of the present invention's Firewall Class Loader, but it would affect the operation of the Limiting Class Loader.

In a particular embodiment, both positive and negative filters are used to take advantage of the hierarchical nature of classes and the containers of classes (packages in Java). Thus, it should be noted that the present invention's Firewall Class Loader is used to implement any combination of positive and/or negative filters (as opposed to the Limiting Class Loader, which can only use a negative filter).

Use of More than One Firewall Class Loader

In another embodiment, multiple Firewall Class Loaders (e.g., a plurality of, or a combination of, any of the following class loaders: PFWCL, NFWCL, or GFWCL) are used in the same class loader hierarchy. As described earlier, FIG. 2 shows an example of using two Firewall Class Loaders.

Firewall Class Loader 2 202 plays a different role to that of Positive Firewall Class Loader 1 206. The former is configured to know the external classes used by the Application Server (those whose interfaces are designed to be used directly by the application). If the application tries to directly load one of the internal classes of the Application Server, then the User Class Loader 200 passes the request to Firewall Class Loader 2 202, which does not pass it upwards in the hierarchy. The request would therefore return to the User Class Loader 200, which may not have sufficient information to know how (and from where) to load the class. The present invention therefore prevents the application or its User Class Loader 200 from raising a class fault that will result in the Application Server Class Loader 204 loading an internal class. However, the Application Server itself can cause an internal class to be loaded because the class fault would first be handled by the Application Server Class Loader 204, which (after involvement of class loaders above it in the hierarchy) is able to load the missing class. Firewall Class Loader 2 202 would not be involved in that case.

It should be noted that neither Positive Firewall Class Loader 1 206, nor Firewall Class Loader 2 202, needs to change its list of filters if the Application Server level is “open”—that is, if its list of classes isn't fixed or stable. The filters for Positive Firewall Class Loader 1 206 need to change only if the System level changes. The filters for Firewall Class Loader 2 202 need to change only if the externals of the Application Level changes, not if the application level adds a plug-in that is used by the Application Server itself.

FIG. 2 also discloses an Application Server and an associated Application Server Class Loader 204 to explain one of the benefits of this invention. However, an Application Server should be viewed as being just one of the sub-systems that benefits from the present invention.

It is interesting to notice the results of replacing the present invention's Firewall Class Loaders 206 and 202 of FIG. 2 with prior art Limiting Class Loaders: Limiting Class Loader 1 and Limiting Class Loader 2. Once again, it should be noted that such modifications do not appear to be disclosed in the documentation of DrJava. Limiting Class Loader 1 can be configured to filter out all requests to load classes normally loaded by the Application Server Class Loader (and, hence, it would protect the Application Server against misconfigurations of the System Class Loader). In one implementation, Limiting Class Loader 2 could be configured to filter requests to load all of the internal classes used by the Application Server (and, hence, it would protect the system from the user level directly loading one of these classes). However, this would mean that the user level would not be protected from misconfiguration of the System Class Loader with respect to one of the classes that it (but not the Application Server) wishes to load. Hence, if the System Class Loader could load an inappropriate implementation of class L1 that is used by the application level, then inappropriate implementation would be loaded. Limiting Class Loader 2 could also be configured to filter out requests to load all classes (or at least class L1) used by the user level, but then it would have to be maintained by the user. (In contrast, no such user configuration is required when two Firewall Class Loaders are used, as in FIG. 2.) A third Limiting Class Loader can be installed below Limiting Class Loader 2 to filter out requests to load classes used by the user level (or at least L1) but, again, this would have to be configured by the user.

In another embodiment, Firewall Class Loader 2 202 is used to allow the application level to use a different implementation of a class than that used by the Application Server level. If the application level uses a particular implementation of class C1 and the Application Server uses a different implementation, then, in the absence of Firewall Class Loader 2 202 (and on the assumption that the System level is not responsible for loading the class), the Application Server Class Loader 204 will load the implementation of C1 (and this will have to be shared by the entire application). With the introduction of Firewall Class Loader 2 202, the Application Server Class Loader 204 loads an implementation of C1 that suits the needs of the Application Server. If the application level loads the same class, then Firewall Class Loader 2 is configured not to pass the request upwards, and the User Class Loader loads an implementation of C1 suitable to the application level.

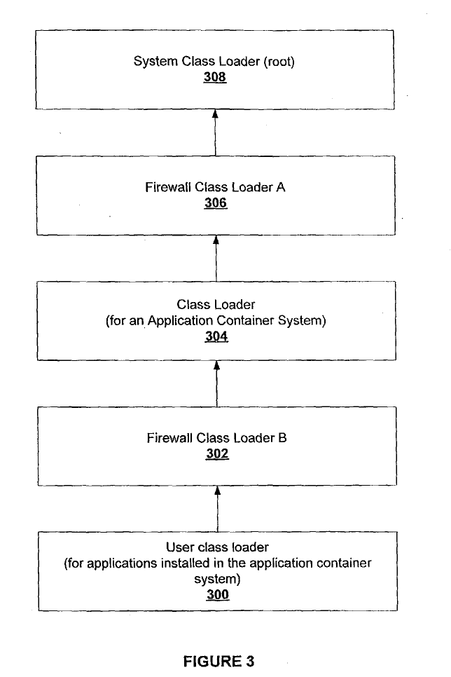

FIG. 3 illustrates an example of the present invention's FWCL used in conjunction with an application container system. The class loader hierarchy (from top to bottom) includes (but should not be limited to) the following class loaders: one or more system class loaders 308, a first FWCL (FWCL 1) 306, a Class Loader 304 for loading the classes for an application container system, a second FWCL (FWCL 2) 302, and one or more user class loaders 300 for loading user-classes for one or more applications installed in the application container system. In this specific example, FWCL 1 306 is configured to only pass requests to load system classes and FWCL 2 302 is configured to only pass requests to load system classes plus public classes as defined in the container contract of the application container system.

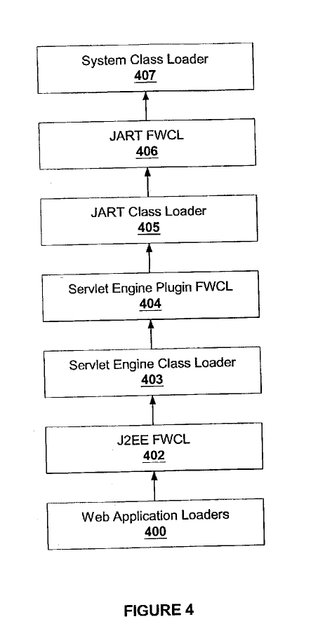

FIG. 4 illustrates a complex system that utilizes the following three FWCLs: a Java™ 2 Platform, Enterprise Edition (J2EE) FWCL 402, Servlet Engine Plugin FWCL 404, and JART FWCL. Web Application Loader 400 loads various Servlet applications classes. The J2EE FWCL 402 is made up of positive filters (and, optionally, some negative filters) that only allow Java 2 Standard Edition (J2SE) and J2EE class loading requests to pass and gives installable servlet application isolation. Servlet Engine Class Loader 403 loads servlet engine internals. Servlet Engine Plugin FWCL 404 is made up of negative filters that stop requests to make sure that the servlet engine class requests don't propagate upwards to be loaded by the Servlet Engine Class Loader 403. JART Class Loader 405 loads JART internal class loading requests. JART or Java Adaptive Runtime Technology is a generic IONA™ Java container architecture that is used to host CORBA, J2EE, or web services containers. JART FWCL 406 is made up of positive filters and only allows J2SE class loading request to pass on to the system class loader 407.

Support for multiple, possibly conflicting, sub-systems

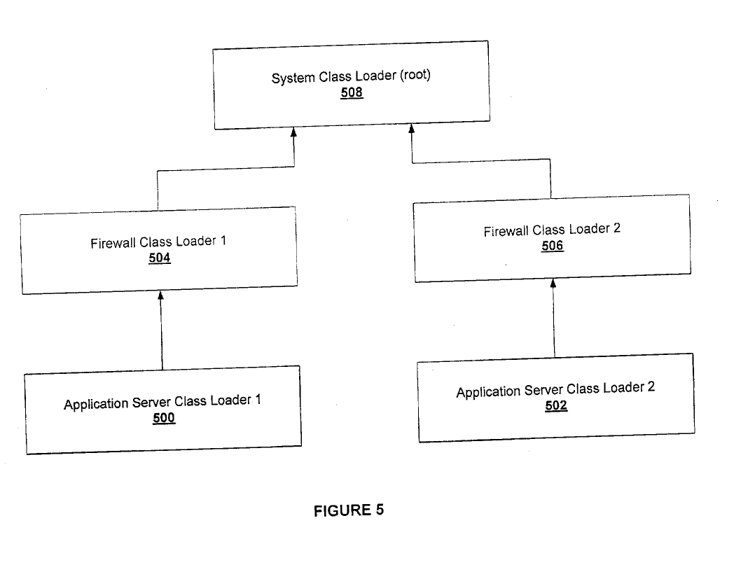

In yet another embodiment, the present invention is used to support two similar sub-systems (for example, two Application Servers) in the same address space and/or application. The difficulty in the prior art is that these two sub-systems may have classes with the same names but with different implementations. Loading the wrong implementation into a sub-system may cause some difficulties. This is solved in the present invention, as shown in FIG. 5. Here there are two Application Server Class Loaders (Application Server Class Loader 1 500 and Application Server Class Loader 2 502) supporting two Application Servers (either from the same vendor or from different vendors). Each of the two Firewall Class Loaders (Firewall Class Loader 1 504 and Firewall Class Loader 2 506) is configured to pass upwards only requests to load classes associated with the system level (using positive filters); or (using negative filters) not to pass requests to load classes associated with its corresponding Application Server up to the System Class Loader 508. This means that each Application Server Class Loader (500 or 502) is responsible for loading the classes associated with its own Application Server. The System Class Loader 508 (nor any other shared level or component) does not need to be configured to know how to load classes associated with either of the Application Servers.

One of the particular benefits of the present invention is that two Application Servers are supported even though it may be difficult or impossible to configure the System Class Loader 508 to know how to load classes associated with more than one Application Server. This may arise, for example, because of conflicts in how the System Class Loader 508 or another loader would have to be configured (for example, in Java, the order of the entries in the system class path is significant). The System Class Loader 508 iterates through the entries in the system class path until it finds an implementation of a class that it is searching for, and it will load this without regard for which Application Server it is associated with.

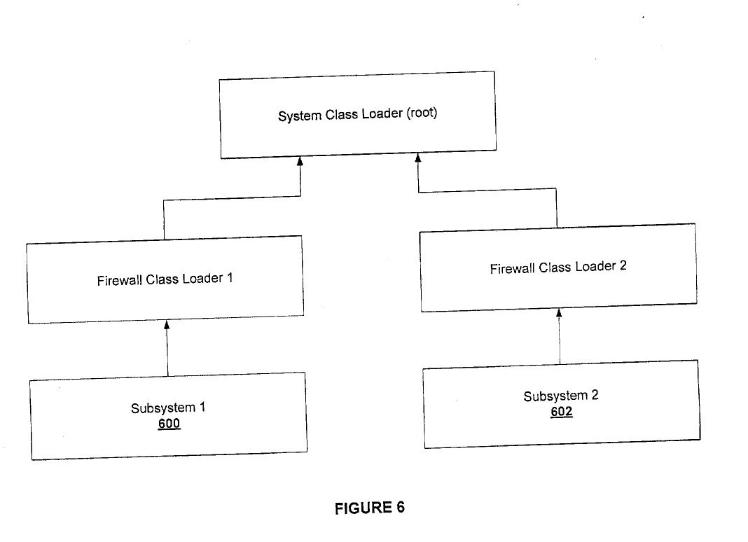

FIG. 5 is an example of how a more general problem is solved with this invention. It shows how two Application Servers and their associated Application Server Class Loaders are supported avoiding a certain type of unwanted interaction. This is also generalized to support two subsystems (see subsystem 1 600 and subsystem 2 602 of FIG. 6) of any type whose class loading requirements might or might not interact, as shown in FIG. 6.

It should be noted that although FIG. 5 and FIG. 6 show two Application Servers and two subsystems, the present invention is configured to support any number of Application Servers and subsystems.

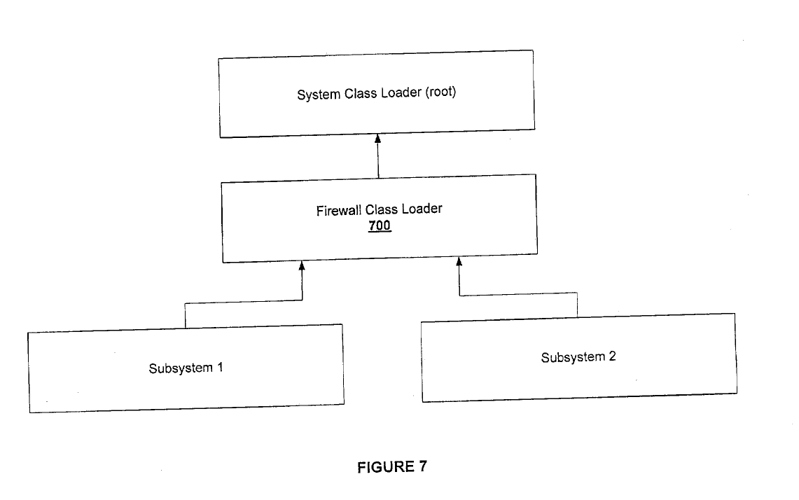

FIG. 7 shows yet another alternative method to achieve the same result, with a single Firewall Class Loader 700. Here a single class loader 700 has been used. Using positive filters (rather than the negative filters of a Limiting Class Loader) allows this to work because the configuration of the Firewall Filter depends only on the System level. The same cannot be done using a single Limiting Class Loader because its configuration would have to depend on possibly conflicting requirements of the two sub-systems.

The approach used in FIG. 7 is easier to maintain than the equivalent approach using two Limiting Class Loaders. The two Limiting Class Loaders would have to be updated if the classes used by their respective Sub-systems were to change. Using a single Firewall Class Loader means that there is only a single place to update and only a single source of change (changes to the System level). Further, the system level is likely to be more stable in many installations.

Speed Improvements

The unique class loader of the present invention provides a speed advantage (over the disclosed prior art) by maintaining a smaller filter list that is efficiently loaded by the Firewall Class Loader. The filter list is smaller for two reasons. Firstly, a typical System Class Loader has to deal with fewer classes than a complex application, especially one built on a complex sub-system such as an Application Server. Secondly, the nested structure of classes and their containers (Java packages) are exploited for speed. The System Class Loader has to deal with only a small number of these containers. It would also be possible to take advantage of the nested structure of classes and their containers using either a set of positive filters or a set containing both positive and negative filters. This setup reduces the number of filters and, hence, speeds up the task carried out by the Limiting Class Loader.

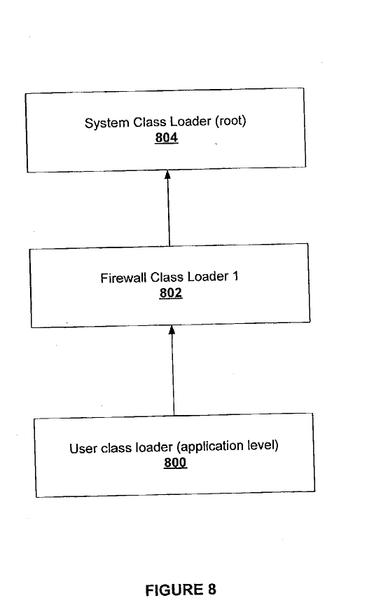

Yet another benefit of this invention is a speed improvement in certain versions of the Java Development Kit™ (JDK). In a simple test, with a class loader hierarchy as outlined in FIG. 8, the system ran faster than with a similar setup without the Firewall Class Loader 802. In this example, the application loads a number of classes that the User Class Loader 800 knows how to load. With the inclusion of the Firewall Class Loader 802 shown in FIG. 6, the Firewall Class Loader 802 prevents these requests to load classes from getting to the System Class Loader 804. Without the Firewall Class Loader 802, all of these requests to load classes gets as far as the System Class Loader 804. Where the System Class Loader 804 adds overhead, this leads to the system running slower in contrast to when the Firewall Class Loader 802 is included. Examples of when the inclusion leads to improved performance are: where the System Class Loader 804 does know how to load the classes but the User Class Loader 800 finds and/or loads them faster; and where the System Class Loader 804 does not know how to load the classes and therefore adds overhead by checking to see if it is able to load them.

TABLE 1
performance figures in ms (two runs per test, preceded by a discarded run)

| | | Test 2: |
|---|---|---|
| | Test 1: | Without Firewall Class |
| | With Firewall Class Loader | Loader |
| Discarded Run | (751) | (1412) |
| Run 1 | 551 | 1142 |
| Run 2 | 471 | 1181 |

Table 1 performance figures in ms (two runs per test, preceded by a discarded run) Table 1 shows some performance figures for version 1.3.1 of the JDK. Two tests were performed. Test 1 used two class loaders: a system class loader as the root, and a URL class loader below it (a URL class loader is also part of the Java JVM). Test 2 used a third class loader (a Firewall Class Loader) positioned between the previous two. The Firewall Class Loader was configured with positive filters to ensure that requests for only JVM classes reached the System Class Loader. Both tests were run two times (using different incarnations of the filters on each run so that the cache inside every JDK class loader would not be brought into play). The results, in elapsed milliseconds, are shown in Table 1. It should be noted that both tests were preceded with a single run whose results were discarded because first runs normally give unreliable results. The discarded result is shown in parentheses.

Configuring a Firewall Class Loader—adding flexibility to the way filters are specified

In this section, the filters that a Firewall Class Loader supports are extended to be either positive, negative, or a mixture of both. There is particular advantage in supporting both types when there is more than one Firewall Class Loader in a class loader hierarchy, and also where classes have hierarchical names to reflect how classes are stored in packages. The present invention uses both types of filters (in both flat and hierarchical scenarios) for use within a class loader that filters out class loader requests.

The present invention's Firewall Class Loader takes benefit of the hierarchical structure of a class packaging mechanism. In Java, for example, classes are stored in packages which, in turn, is stored in other packages, and so on. At any particular level, the following filters could be set:

default reject (do not pass the class load request to the parent class loader but reject it instead);

default accept (pass the class load request to the parent).

At any given level, the filter set at that level applies to that package and all packages and classes within it, unless the filter is changed for one of the nested packages or classes. If any given level is default reject, then the default for a package within that level is changed to default accept; and vice versa. In addition, a filter to allow the loading of an individual class is specified; or a filter is set to disallow such loading.

A class is loaded if the package that immediately encloses it is loaded and if the class does not have a filter that disallows the loading of that particular class. It is also loaded if there is a filter that allows the loading of that particular class.

Notation A.B.C is used to mean package C is within package B which is within package A. Considering a particular example, if package A has default reject set, and package B has default accept, then this means that (in the absence of other filters) all of the classes in package B and C would be passed up (or, more exactly, requests to load them would be passed to the parent class loader). If a new default reject filter were added to package C, then all of the classes in package B would be passed up by default except for those in package C. All of the other contents of package A would be rejected by default.

Notation A.B.D is used to mean class D is within package B which is within package A. If A has a default accept filter and B has a default reject filter, then class D will only be passed up (or more exactly, requests to load it would be passed to the parent class loader) if it has an explicit filter that allows it to be loaded. If A had a default reject filter and B had a default accept filter, then requests to load D would be accepted only if it does not have an explicit reject filter.

It should be noted that specific notations and levels of nesting (of packages), as described in the above-mentioned examples, are used for descriptive purposes only, and hence, should not be used to limit the scope of the present invention. Furthermore, other notations (i.e., other than the notations disclosed) and levels of nesting fall within the scope of the present invention. Additionally, it should be noted that the negative, positive, and general filters take advantage of the hierarchical structure of the class-packaging mechanism (e.g., how java classes are contained in Java packages).

An example benefit of using the above aspect of this invention is as follows. In the instance that the class loader hierarchy is configured (from top to bottom) with a System Class Loader, a Firewall Class Loader, and a User Class Loader (for the application level), the application level may wish to use the Firewall Class Loader to protect itself from misconfigurations of the System Class Loader. The Firewall Class Loader could therefore be configured with a set of positive filters for the classes that the System Class Loader should load. These could either enumerate all of the classes that the System Class Loader is to load, or they could list the high-level packages that the System Class Loader has load responsibility for (the latter approach is more efficient because the list of filters is smaller, and also it is easier to maintain since only changes to the high-level list of packages require changes in the configuration). Assume, further, that the application level wishes for some reason to take responsibility for loading a particular class that the System Class Loader would normally load. This is done with a simple combination of default-accept and default-reject filters.

It should be noted that PFWCLs, NFWCLs, and GFWCLs are able to use the hierarchical names for classes/resources (reflecting the fact that classes are stored in packages, which are in turn be stored in other packages, to any level of nesting). In addition, wild-cards are used when referring to groups of classes (for example, a package name is implicitly or explicitly extended with a wildcard to refer to all of the classes and packages (and hence the classes within those packages, and so on recursively) contained within).

Other Implementations of the Invention

Other embodiments of the present invention include:

1. Combine Firewall Class Loader Up or Down

Instead of using a separate Firewall Class Loader, its functionality (including ability to filter out requests to load classes) is combined with any other class loader. For example, its functionality is combined (into a single class loader) with the class loader for an application server, another subsystem, or with an application (user level). One way to achieve this is explained in item 3 of this list.

2. Implementation Within the Environment, e.g., Within the JVM

The present invention runs within an unmodified JVM, but another embodiment is also envisioned wherein the JVM is modified (or another part of the support environment)—for example, to build the filtering facility provided by our Firewall Class Loaders into the JVM (or another part of the support environment) itself.

(Using the filters of the next class loader up in the hierarchy): In one implementation, the JVM (or another part of the support environment), such as a class loader manager, could associate a set of filters with each class loader in the hierarchy and pass the request to load a class up to the next class loader in the hierarchy only if that next class loader's filters indicate that it is appropriate to do so.

(Using the filters of the current class loader): In yet another implementation, the JVM (or another part of the support environment) could associate a set of filters with each class loader in the hierarchy and pass the request to load a class up to the next class loader in the hierarchy only if the current class loader's filters indicate that it is appropriate to do so.

3. Using Primitive Building Blocks

Class loaders provide the following primitive building blocks: a Firewall Class Loader, an Up Class Loader, and a Down Class Loader.

A Firewall Class Loader, as explained before, is configured to not pass requests to load certain classes up to its parent in the class loader hierarchy.

A Down Class Loader is the normal type installed in a class loader hierarchy, for example, the Application Server Class Loader shown in FIG. 2. It passes the request to load a class to its parent, and it tries to load the class if the parent and its ancestors do not.

An Up Class Loader is able to load a class (using a configuration mechanism to tell it what classes it is allowed to load and where to look for those classes); however, the timing of when it does this loading is different. Whereas a Down Class Loader attempts to load a class when a class loading request returns (in failure) from its parent in the class loader hierarchy, an Up Class Loader attempts to load a class when it receives a request to load a class from one of its children. If it cannot load the class, then it passes the request to its parent.

Each of these three types of class loaders are able to be positioned anywhere in the class loader hierarchy.

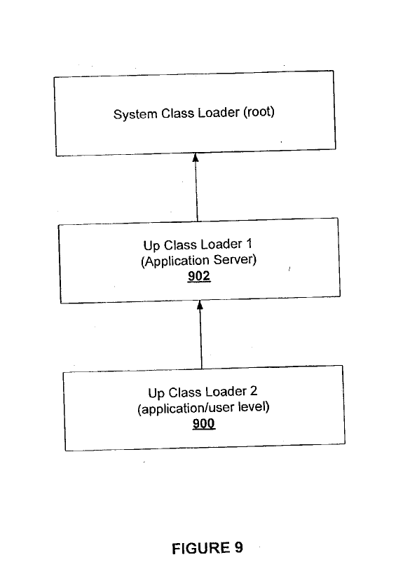

An Up Class Loader has the benefit to simplify FIG. 2 to the structure shown in FIG. 9. Up Class Loader 1 900 in FIG. 9 is configured to load only classes associated with the Application Server and to pass all other class load requests that it receives to its parent. Up Class Loader 2 902 is configured to load only classes associated with the application level and to pass all other class load requests that it receives up to its parent.

Composition of Class Loaders

In a particular embodiment, more than one class loader is used in a class loader hierarchy, as shown, for example, in FIG. 2. The filter set for Firewall Class Loader 1 could list the (positive) filters for the System level. The filter set for Firewall Class Loader 2 could list the (positive) filters for the Application Server and for the System. The maintenance of Firewall Class Loader 2 is, therefore, more difficult because certain changes to either the System level or the Application Server cause it to need an update in its filter set. Certain changes to the System level cause both Firewall Class Loaders to need an update. This need for a double-update is removed by sharing information (for example, the positive filter set associated with the System) between the two Firewall Class Loaders. This is done by having sets of filters (that both Firewall Class Loaders are able to use) and assigning names or references to these filter sets, and also allowing both Firewall Class Loaders to have these names or references (these references could take the form of URLs).

In yet another implementation, this is achieved by allowing Firewall Class Loader 2 to make a call on Firewall Class Loader to ask it to check a class-load-request against the set of filters that it stores.

In yet another implementation, a “third-party” entity could provide a service to both of the Firewall Class Loaders to allow them to check a class-load-request against the set of filters that it stores.

Yet another way to achieve sharing of filter specifications is to use class inheritance. Referring to FIG. 2, Firewall Class Loader 1 could be an instance of a class that knows its filters (or how to find them using a name or a reference of some sort). Firewall Class Loader 2 could be an instance of a class that inherits from the class of which Firewall Class Loader 1 is an instance. Firewall Class Loader 2 could check its own filters and those of all of the classes from which it inherits (recursively).

Adding more than one filter to a class loader hierarchy is also possible with negative filters (Limiting Class Loader). The Limiting Class Loader nearest the application level would first see the classloading request and would not pass it upwards if the class matched the Limiting Class Loader's filters. No reference to Limiting Class Loaders further up in the class loader hierarchy is required.

However, the present invention extends this ability by allowing for a mixture of positive and negative filters, especially in the context of supporting filters that take advantage of the hierarchical structure of the class packaging mechanism. Negative filters and positive filters have different advantages, including the following:

positive filters are better at supporting open systems;

multiple negative filters are added to a single class loader hierarchy without requiring class loaders further down in the hierarchy to use the filter set of those above it (or have its own copies of these).

By supporting both positive and negative filters, a user has the choice of which of these advantages he wishes to have for different parts of the overall set of classes he is using. Referring to FIG. 2, for example, Firewall Class Loader 2 could have a negative filter (default reject) on those packages of classes used by the Application Level (and this may make sense, for example, if the Application level is not an open system, meaning that its set of classes is reasonably well known to the user). Firewall Class Loader 1 could have a positive filter for the classes (and/or packages of classes) used by the System level. The list of classes used by the Application Server level would then not need to appear in either of the filter sets of either of the two Firewall Class Loaders. This would be especially useful if the Application Server had a very dynamic set of classes (and/or packages), or this set was very large.

Automatic FireWall Class Loader Filter Discovery

The filters in a FireWall Class Loader consist of package names. A package name in a filter will also apply to all sub-packages of that package, so, in essence, the package name is seen as having a wildcard at the end, e.g., a “java.” filter will also cover “java.lang.”, “java.lang.reflect.”, “java.io.”, and so on.

These filter names are automatically discovered by inspecting the contents of libraries (e.g. Java™ jar files).

An implementation opens the jar file and examines all the classes and resources inside this library. For every such element, the package name can be added to the list of packages used by the FireWall Class Loader. The package name is obtained by looking at the directory in which an element resides, e.g., the file org/omg/CORBA/ORB.class corresponds to the package name org.omg.CORBA.

When all the packages are assessed, an optimizing process reduces the number of package filters by generalizing them. For example, org.omg.CORBA and org.omg.CosNaming are generalized to org.omg.

The optimization process has configurable minimum package settings that describe the default minimum number of packages in a filter and also exceptions to this rule. For example: the default minimum package setting could be three, but an exception could be made for packages starting with “omg.”, which are set to have a minimum package level of 2. This results in a filter list as follows:

com.iona.servlet.

com.iona.corba.

com.iona.ejb.container.

org.omg.

org.w3c.

org.xml.

Specifying a minimum package level does not mean that all filters will have this minimum number of elements. Generalization is done only if useful. For example, in the above example, it is not necessary to generalize “com.iona.ejb.container” further. The generalization process should leave filters as specific (as long) as possible, only generalizing if this reduces the number of filters.

Additionally, an implementation of the filter discoverer caches discovered filters in a cache file so that subsequent requests for filters for the exact same library under the same configuration loads the discovered filters from the cache to improve performance.

The discovery process is also used to automatically discover all filters needed to expose all packages provided by the currently running virtual machine. More specifically, the process is used to discover everything needed to expose the Java TM libraries provided by the currently running JVM. This is done by applying the automatic discoverer, as described above, at runtime on the libraries available with the current environment.

Optimizing the FireWall Class Loader Filter Handling

FireWall Class Loader filters may contain a set of packages” names of classes or resources, as well as the names of individual classes. These package names that are handled by the FWCL are implemented in a number of ways. It is important that the implementation is fast, because every class, or resource, “fault” will have to go through the filter handler.

1. In one implementation, the Fire Wall Class Loader makes use of arrays or lists that simply enumerate all packages applicable to the current filter set. This simple implementation has very little overhead in itself, so it is fast in that sense, but it doesn't scale very well. If the list of filters grows very large, the implementation may slow down because a significant list of filters has to be traversed every time a class or resource is required.

A performance improvement here would be to sort the filters by usage count. The most often used filter (e.g. “java.”) would come first. In addition, storage using sorted lists helps in certain instances.

2. In yet another implementation, the filters would be organized into a tree. This makes use of the fact that packages themselves are organized as a tree.

The root of the tree would be a map where all registered root package names are keys (e.g. “java”, “org”, “com”, etc). The corresponding value to every key would be a new map having values of the second level (so the org key would be associated with a second map that has “omg”, “w3c”, and “xml” as keys).

This implementation has more overhead in itself, as accessing the maps would be more expensive than traversing through a flat list. However, this implementation would scale much better if implemented with the appropriate types of maps. Normally, a filter would be found in a few “hops”, e.g., to find a filter for the class org.omg.CORBA.ORB would cost, at most, three hops.

In addition, an implementation of FireWall Class Loader dynamically decides on the best performing implementation of the search function for the current filter set. If the set is small, the first implementation above could be used; if the filter set is large, the second implementation could used.

Delegation Class Loader

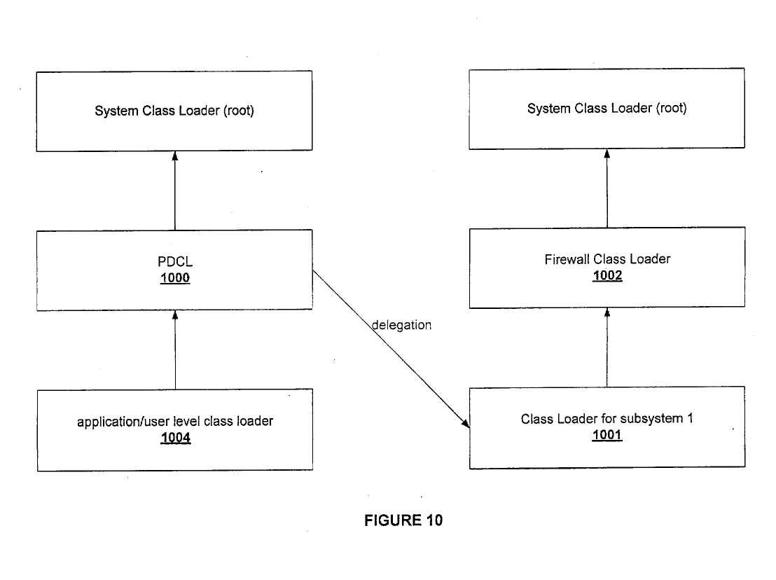

The present invention also provides for Preference Delegation Class Loaders (PDCL). A PDCL accepts class loader requests from class loaders below it in the class loader hierarchy (it can also be a leaf node). It passes these requests to one or more other class loaders that need not be its parent, as shown in FIG. 10. If the class that the PDCL 1000 delegates to can load the class, then the PDCL 1000 returns (in success) to its child that called it. If the class that the PDCL 1000 delegates to cannot load the class, then the PDCL 1000 passes the request to its own parent. FIG. 10 shows a use of a PDCL 1000 and a Firewall Class Loader 1002. The Firewall Class Loader 1002 could be configured to pass upwards only class load requests for the System. This means that the Class Loader for sub-system 1 1001 would be given the chance to load all classes that the System Class Loader does not have responsibility for.

Assume that the application wishes to have class Cl loaded. The application/user level class loader 1004, and then the PDCL 1000, would first see the request. The PDCL 1000 would delegate this to the Class Loader for sub-system 1 1001, which would pass it to the Firewall Class Loader 1002. The Firewall Class Loader 1002 could use a positive filter set to reject this class load request (C1 is not listed as part of the filter set). Assume also that the Class Loader for sub-system 1 1001 does not load C1. The PDCL 1000 would then get control back and return it to its parent, the System Class Loader. If the System Class Loader has the ability to load C1, it would do so. The result is that:

the Class Loader for sub-system 1 1001 is given the first chance to load any class that is filtered out by the Firewall Class Loader 1002;

the System Class Loader is given the next chance to load any class that the Class Loader for sub-system 1 1001 does not load;

finally, if neither 1001 nor the System Class Loader can load the requested class, class loader 1004 is given a chance to load the class.

It should be noted that a PDCL acts very much like an Up Class Loader that has been configured to know the classes for sub-system 1.

In addition, the three primitive types of class loaders (Down, Up, Firewall) plus the PDCL type is combined together in any combination. For example, a Firewall Class Loader can be combined with an Up Class Loader or a Down Class Loader to form a hybrid class loader, and this hybrid can be placed in any position in a class loader hierarchy.

Lastly, a non-exhaustive list of some of the uses of the present invention's system is provided below.

The present invention is used in protecting an application server from badly configured Java run-time systems.

The present invention is used in protecting applications (installed in the application server) from internals used by the application server.

The present invention is used in preventing applications installed in the application server from loading/accessing internal classes of the application server at runtime.

The present invention is used for giving the user the capability of hiding elements implemented by the application server and replacing them with a user's own implementation. As an example, the application server provides a JAXP (Java API for XML Parsing) XML parser to installed applications. However, situations exist where the user requires another XML parser and the FWCL is used to hide application server-provided XML parser implementation giving the user the capability to override it.

The present invention is used to selectively expose elements from the system classpath. Customers might want to have the capability of selecting elements on the system classpath (that they do want exposed to their applications running in the application server) while being able to control the rest of the Java Runtime class loading. In this scenario, the FWCL can be configured to only expose these elements.

The present invention is used in protecting the Object Resource Broker (ORB) from badly configured Java Runtime systems

The present invention is used in hiding elements in the ORB implementation so they can be provided/overridden by IONA ORB plug-ins.

The present invention is used to let a first products run inside a second product (or a plurality of other products) without exposing the second product's classes. If the first product was to see the second product's classes, it could be badly affected by it.

The present invention is used to let multiple subsystems with conflicting class loading requirements run in the same environment. For example, running an XMLBUS and the Application server in the same virtual machine wherein the XMLBus requires libraries that conflict with the application server library requirements.

The present invention is used to run multiple CORBA implementations in the same Java Runtime instance (VM).

The present invention is also used in the ASP deployer to allow elements outside of the deployer replace deployer internal tasks.

Computer Program Listing Appendix

This specification includes a Computer Program Listing Appendix A having 8 files named: FireWallClassLoader.java.txt, created on Jan. 8, 2003, which is 12 kilobytes in size; FireWallClassLoaderTools.java.txt, created on Jun. 11, 2002, which is 5 kilobytes in size JarCacheTypeSelector.java.txt created on Jan. 7, 2002, which is 2 kilobytes in size; JARPackageDiscovererjava.txt created on Feb. 7, 2003, which is 1 5 kilobytes in size; JARPackageDiscovererSettings.java.txt created on Feb. 7, 2003, which is 2 kilobytes in size; JDKFireWallClassLoaderFactoryjava.txt created on Aug. 23, 2002, which is 4 kilobytes in size; JDKPackageDiscovererjava.txt created on Feb. 7, 2003, which is 5 kilobytes in size; and PreferenceDelegationClassLoader.java.txt created on Aug. 23, 2002, which is 2 kilobytes in size; and are incorporated herein by reference.

### CONCLUSION

A system and method has been shown in the above embodiments for the effective implementation of a firewall class loader. While various preferred embodiments have been shown and described, it will be understood that there is no intent to limit the invention by such disclosure but, rather, it is intended to cover all modifications and alternate constructions falling within the spirit and scope of the invention, as defined in the appended claims. For example, the present invention should not be limited by type of resource loader, type of filter, number of filters, specific combinations of filters, type of inspection (automatic or manual), hierarchical or flat class structure, software/program, or computing environment.

All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of programming in a resource loader based language such as Java (which uses class loaders).

1. A system for evaluating a class loading request comprising:
a parent class loader; and
at least one child class loader configured to pass said class loading request to said parent class loader only if one or more criteria are met.

2. A system for evaluating a class loading request, as per claim 1, wherein said criteria are implemented using at least one filter, said at least one filter defining if said class loading request is to be allowed to pass.

3. A system for evaluating a class loading request, as per claim 1, wherein said criteria are implemented using at least one positive filter, said at least one positive filter defining if said class loading request is to be allowed to pass.

4. A system for evaluating a class loading request, as per claim 1, wherein said criteria is implemented using a combination of positive and negative filters.

5. A system for evaluating a class loading request, as per claim 2, wherein said filters are based on an identifier associated with said requested class to be loaded.

6. A system for evaluating a class loading request, as per claim 5, wherein said identifier is a class name including a package identifier.

7. A system for evaluating a class loading request, as per claim 6, wherein said filter uses a hierarchical naming of classes to refer to groups of classes.

8. A system for evaluating a class loading request, as per claim 7, wherein said filter uses default accept and default reject to handle said hierarchical naming of classes.

9. A system for evaluating a class loading request, as per claim 7, wherein said filter uses wildcards within said hierarchical naming of classes to refer to groups of classes.

10. A system for evaluating a class loading request, as per claim 9, wherein said filter uses default accept and default reject to handle said hierarchical naming of classes.

11. A system for evaluating a class loading request, as per claim 1, wherein at least one of child class loaders is a firewall class loader in a class loader hierarchy.

12. A system for evaluating a class loading request, as per claim 11, wherein said firewall class loader is any of, or a combination of, the following: a positive firewall class loader, a negative firewall class loader, or a general firewall class loader.

13. A system for evaluating a class loading request, as per claim 11, wherein said firewall class loaders use more than one positive filter.

14. A system for evaluating a class loading request, as per claim 11, wherein said firewall class loaders in the loader hierarchy use either positive filters or negative filters.

15. A system for evaluating a class loading request, as per claim 1, wherein each of the firewall class loaders use a combination of positive and negative filters.

16. A system for evaluating a class loading request, as per claim 11, wherein said at least one child class loader in said class loader hierarchy comprises two firewall class loaders: a first firewall resource loader using positive filters listing the classes that class loaders above said first firewall class loader should be allowed to load, and a second firewall class loader using negative filters listing the classes that the class loader above said second firewall class loader should not load.

17. A system for evaluating a class loading request, as per claim 11, wherein said at least one child class loader in said class loader hierarchy comprises two firewall class loaders, a first firewall class loader using positive filters listing the classes that class loaders positioned above said first firewall class loader should load, and a second firewall class loader using positive filters listing the classes that class loaders above said second firewall class loader should load.

18. A system for evaluating a class loading request, as per claim 2, wherein said filters are constructed through an automated process.

19. A system for evaluating a class loading request, as per claim 1 8, wherein the automated process involves inspecting the libraries/archives used by systems/subsystems associated with said class loaders above or below a particular point in the loader hierarchy and constructing one or more filters from the set of classes in these libraries/archives.

20. A system for evaluating a class loading request, as per claim 11, wherein the actions of a firewall class loader are combined with other class loaders.

21. A system for evaluating a class loading request, as per claim 1, wherein said system protects an application server from badly configured Java run-time systems.

22. A system for evaluating a class loading request, as per claim 21, wherein multiple CORBA implementations are run in said run-time system.

23. A system for evaluating a class loading request, as per claim 21, wherein multiple subsystems with conflicting class loaders requirements run in the same run-time system.

24. A system for evaluating a class loading request, as per claim 21, wherein said system protects applications installed in said application server from internals used by said application server.

25. A system for evaluating a class loading request, as per claim 21, wherein said system prevents applications installed in said application server from loading/accessing internal classes associated with said application server at run-time.

26. A system for evaluating a class loading request, as per claim 2, wherein said filters override loading of one or more container classes to enable loading one or more plug-ins.

27. A system for evaluating a class loading request comprising:
one or more class loaders, and
a class loader manager to control loading of classes via a sets of filters,
wherein said control is exercised to determine which of said class loaders are given an opportunity to load a class.

28. A system for evaluating a class loading request, as claim 27, wherein said class loader manager associates a set of filters with each of said class loaders.

29. A system for evaluating a class loading request, as per claim 27, wherein said class loader manager is any of the following: JVM or C#/.Net run-time environment.

30. A system for evaluating a class loading request, as claim 29, wherein said class loader manager associates a set of filters with each of said class loaders.

31. A system for evaluating a class loading request, as claim 30, wherein said class loader manager passes a request to load a class up to a next class loader in the hierarchy only if that class loader's filters indicate that it is appropriate to do so.

32. A system for evaluating a class loading request, as per claim 30 wherein said class loader manager passes a request to load a class up to a next class loader in the hierarchy only if the current class loader's filters indicate that it is appropriate to do so.

33. A system for evaluating a class loading request, as per claim 27, wherein at least one of said class loaders is a firewall class loader used in conjunction with said at least one up class loader.

34. A system for evaluating a class loading request, as per claim 33, wherein at least one of said class loaders is a down loader used in conjunction with said at least one firewall class loader and at least one up class loader.

35. A system for evaluating a class loading request, as per claim 27, wherein said at least one of said class loader is functionally combined with any of, or a combination of, the following class loaders: up class loader, down class loader, positive firewall class loader, negative class loader, general class loader, or preference delegation class loader.

36. A system for evaluating a class loading request, as per claim 27, wherein a sub-set of said set of filters are shared between said class loaders.

37. A system for evaluating a class loading request, as per claim 36, wherein said sharing of sub-set of said set of filters is implemented in any of the following ways: filter or filter sets having names and use of the same names implies sharing of a filter or filter set, direct or indirect communication between class loaders that share filters or filter sets, or sharing by inheritance of class implementations.

38. A system for evaluating a class loading request, as per claim 33, wherein a sub-set of said set of filters are shared between two or more firewall class loaders.

39. A system for evaluating a class loading request traversing a hierarchy of class loaders, said hierarchy of class loaders comprising:
at least one up class loader, said up class loader loading a class when requested to do so by a class loader below it in said hierarchy of class loaders, or directly by an application or environment, and
if said up class loader cannot load said requested class, said up class loader passing said class loading request to a class loader above it in said hierarchy of class loaders.

40. A system for evaluating a class loading request traversing a hierarchy of class loaders, as per claim 39, wherein said up class loader is a preference delegation class loader that delegates to at least one other class loader before possibly passing a class request up in said hierarchy of class loaders.

41. A system for evaluating a class loading request comprising:
a hierarchical class loader structure, said structure comprising a plurality of class loaders,
a firewall class loader operatively connected within said hierarchy and configured to selectively filtering class loading requests traversing said hierarchical class loader structure, wherein
said firewall class loader uses positive or a combination of positive and negative filters.

42. A system for evaluating a class loading request, said request propagating upward in a hierarchy of class loaders, said hierarchy of class loaders comprising from top to bottom:
a. one or more system class loaders as provided by a system;
b. a first positive firewall class loader configured to pass requests to load system classes;
c. a class loader for loading classes for an application container system;
d. a second positive firewall class loader configured to pass requests to load system classes and public classes as defined in a container contract of said application container system; and
e. one or more class loaders for loading user classes for one or more applications installed in said application container system.

43. A system for evaluating a class loading request, said request propagating upward in a hierarchy of class loaders, as per claim 42, wherein said system is any of the following: JVM run-time environment or C#/.Net run-time environment.

44. A method for evaluating a class loading request in a hierarchical class loader structure, said method comprising the steps of:
a. receiving in a node of said hierarchical class loader structure one or more class loading requests;
b. selectively filtering said class loading requests traversing said hierarchical class loader structure, said filtering based upon either positive filters or a combination of positive and negative filters; and
c. passing to a parent of said node filtered class loading requests.
